(19) United States
(12) Patent Application Publication
(10) Pub. No.: US 2008/0118344 A1
(43) Pub. Date: May 22, 2008

(54) Helical Gear Supporting Structure, Speed Increaser for Wind Power Generator, and Vertical Shaft Supporting Structure

(76) Inventors: Naoki Matsumori, Mie (JP); Junichi Hattori, Aichi (JP)

Correspondence Address: CLARK & BRODY, 1090 VERMONT AVENUE, NW, SUITE 250, WASHINGTON, DC, 20005, US

(21) Appl. No.: 11/795,752

(22) PCT Filed: Nov. 11, 2005
(86) PCT No.: PCT/JP05/20742

§ 371 Date: Jul. 20, 2007

(30) Foreign Application Priority Data
Jan. 25, 2005 (JP) 2005-017112
Jan. 25, 2005 (JP) 2005-017113

(51) Int. Cl. F01B 25/06; F03D 11/02; F16H 1/08; F16H 1/28

(52) U.S. Cl. 415/45; 475/11; 384/495

(57) ABSTRACT

In a support structure supporting a shaft of a helical gear, a shaft of a speed increase for a wind power generator with a helical gear, or a vertical shaft by a double row rolling element, the double row rolling bearing is so formed that load capacities on the bearing in the right and left rows are different from each other so that the load capacity on the bearing in the row where the rolling bearing receives a large axial load can be increased.

### TECHNICAL FIELD

The present invention relates to a helical gear supporting structure, a speed increaser for a wind power generator comprising a helical gear, a vertical shaft supporting structure, and a swing speed reducer comprising a vertical shaft.

### BACKGROUND ART

Regarding a speed increaser for a wind power generator, Japanese Unexamined Patent Publication No. 2000-337246 discloses a speed increaser for a wind power generator comprising a planet gear mechanism, for example. According to this document, a speed increaser 1 for a wind power generator comprises an input shaft 2 rotating together with a blade receiving wind power, an output shaft 3 supported by a double row roller bearing 4 and connected to a generator, and a planet gear mechanism 5 increasing the rotation speed of the input shaft 2 and transferring it to the output shaft 3 as shown in FIG. 1.

The planet gear mechanism 5 comprises a sun gear 6 connected to the output shaft 3, an internal gear 7 fixed to a housing, and a planet gear 8 connected to the input shaft 2 through a bearing 9 and engaging with the sun gear 5 and the internal gear 6. A helical gear that is smooth in transmission, low in vibration sound and capable of transferring great force is used for the sun gear 6, the internal gear 7 and the planet gear 8.

When the planet gear goes around the sun gear 6 with the rotation of the input shaft 2, it engages with the internal gear 7 and rotates. The sun gear 6 engages with the rotating planet gear 8 and transfers the rotation of the input shaft 2 to the output shaft 3. At this time, the more the difference in the number of teeth between the sun gear 6 and the internal gear 7 is, the more the rotation speed of the input shaft 2 is increased and it is transferred to the output shaft 3.

FIG. 2A is a view showing the state in which a helical gear 71 engages with a helical gear 72. When the helical gear 71 rotates clockwise viewed from the right side in the drawing, as shown in FIG. 2B, power F that is resultant force of a component force Fr in the radial direction and a component force Fa in the axial direction is applied to the helical gear 71 when the helical gear 71 engages with the helical gear 72.

When this is applied to the speed increaser 1 for the wind power generator shown in FIG. 1, in a case where the output shaft 3 rotates clockwise viewed from the double row roller bearing 4, the double row roller bearing 4 receives the axial load from the sun gear 6 to the right direction in the drawing. Thus, the double row roller bearing 4 is required to have the ability to support both radial load and axial load.

At this time, while both radial load and axial load are applied to one row of the double row roller bearing 4, only the radial load is applied to the other row. Therefore, the rolling fatigue lifetime of the highly loaded row becomes short. Meanwhile, sliding is generated between the roller and the track surfaces of the inner and outer rings in the lightly loaded row, which causes surface damage and abrasion. Although it is considered that the bearing size is increased in order to correspond to a large load, there is too much room for the lightly loaded side, which is not economical.

Japanese Unexamined Patent Publication No. 6-330537 discloses a swing speed reducer for swinging a swing body provided in a hydraulic shovel and the like. FIG. 3 is a schematic sectional view showing the swing speed reducer disclosed in the above document.

Referring to FIG. 3, the swing speed reducer 101 comprises an input shaft 102 connected to a power generator such as a hydraulic motor and the like, an output shaft 103 supported by a double row roller bearing 105 and transferring the rotation of the input shaft 102 to a gear 106, a planet gear mechanism 104 reducing the rotation speed of the input shaft 102 and transferring it to the output shaft 103, and an internal gear 111 fixed to a housing and engaging with the gear 106, and it is fixed to the inside of the swing body like the hydraulic shovel and the like.

The input shaft 102 and the output shaft 103 are vertical shafts supported perpendicularly. Here, the vertical shaft is not necessarily supported in a vertical direction strictly, and includes a case where it is supported at a certain angle inclined from the vertical direction.

The planet gear mechanism 104 comprises a sun gear 107 connected to the input shaft 102, an internal gear 108 fixed to the housing and a planet gear 109 connected to the output shaft 103 through a bearing 110 and engaging with the sun gear 107 and the internal gear 108.

The swing speed reducer 101 shown in FIG. 3 operates as follows.

When the sun gear 107 rotates with the rotation of the input shaft 102, the planet gear 109 engages with the sun gear 107 and rotates. Then, the planet gear 109 engages with the internal gear 108 and the planet gear 109 revolves along the internal gear 108, whereby the rotation speed of the input shaft 102 is reduced and it is transferred to the output shaft 103. At this time, the more the difference in the number of teeth between the sun gear 107 and the internal gear 108 is, the more the rotation speed rate is reduced.

With the rotation of the output shaft 103, the gear 106 engages with the internal gear 111 and the gear 106 revolves along the internal gear 111, whereby the swing body swings.

A load in the vertical downward direction is applied to the output shaft 103 in the swing speed reducer 101 shown in FIG. 3 by its own weight and the weight of the swing body and the like. Therefore, the double row roller bearing 105 supporting the output shaft 103 is required to have high axial load carrying capacitance.

Thus, a double row self-aligning roller bearing or a double row conical roller bearing are used as the bearing that supports the vertical shaft such as the output shaft 103 in the swing speed reducer 101.

However, since the axial load is not uniformly applied to the right and left rows of the double row roller bearing, the rolling fatigue lifetime in the row on the highly loaded side becomes short. Meanwhile, sliding is generated between the roller and the track surfaces of the inner and outer rings in the row on the lightly loaded side, causing surface damage or abrasion. Although it is considered to increase the bearing size in order to correspond to the large load, there is too much room on the lightly loaded side, which is not economical.

### DISCLOSURE OF THE INVENTION

It is an object of the present invention to provide a helical gear supporting structure comprising a double row roller bearing that can appropriately support a gear in accordance with the load status of each row in an environment in which different loads are applied to right and left rows, elongate a substantial lifetime, and be economical without wasting its material, and a speed reducer for a wind power generator comprising such helical gear supporting structure.

It is another object of the present invention to provide a vertical shaft supporting structure comprising a double row roller bearing that can appropriately support a gear in accordance with the load status of each row in an environment in which different loads are applied to right and left rows, elongate a substantial lifetime, and be economical without wasting its material.

A helical gear supporting structure according to the present invention comprises a helical gear having a center shaft and a double row roller bearing incorporated in a fixing member and rotatably supporting the center shaft. Focusing on the double row roller bearing, it is characterized in that the load capacities in the right and left rows are differentiated from each other such that the load capacity of the row receiving a high axial load is larger.

In this constitution, since appropriate support can be implemented according to the characteristics of the load applied to the center shaft, the helical gear supporting structure can be high in reliability and have a long lifetime.

It is preferable that the double row roller bearing is a double row self-aligning roller bearing comprising an inner ring having a track surfaces in the right and left rows, an outer ring having a spherically recessed track surface, and spherical rollers arranged in double rows between the inner ring and the outer ring. Thus, the double row roller bearing has self-alignment properties against center displacement due to deflection of the shaft and the like.

Preferably, the double row self-aligning roller bearing has different roller lengths in the right and left rows and the roller length of the roller in the row receiving a high axial load is longer. Thus, the load capacity of the row having the longer spherical roller can be higher.

Preferably, the double row self-aligning roller bearing has different roller diameters in the right and left rows and the roller diameter of the roller in the row receiving a high axial load is larger. Thus, the load capacity of the row having the spherical roller whose diameter is larger can be higher.

Furthermore, it is preferable that the double row self-aligning roller bearing has the same contact angle in the right and left rows. Thus, since a symmetric standard ring can be used for the outer ring, its manufacturing cost can be low. Furthermore, when precision of the outer ring is measured, since the right and left rows can be measured under the same measuring condition, the measurement can be effectively made.

It is preferable that the double row roller bearing is a double row conical roller bearing comprising an inner ring having track surfaces in the right and left rows, an outer ring, and conical rollers arranged in double rows between the inner ring and the outer ring.

Preferably, the double row conical roller bearing is a back-to-back bearing in which the small diameter side ends of the conical rollers in the right and left rows are opposed. In this constitution, the distance between intersections of the center line of the rotation of the bearing with contact lines of the conical rollers in the right and left rows and the inner and outer rings (referred to as the distance between points of action hereinafter) is long, radial load carrying capacitance and moment load carrying capacitance can be improved.

It is preferable that the double row conical roller bearing is a face-to-face bearing in which the large diameter side ends of the conical rollers in the right and left rows are opposed.

Preferably, the double row conical roller bearing has different roller lengths in the right and left rows and the roller length of the roller in the row receiving a high axial load is longer.

Preferably, the double row conical roller bearing has different roller diameters in the right and left rows and the roller diameter of the roller in the row receiving a high axial load is larger.

Preferably, a speed increaser for a wind power generator according to the present invention comprises an input shaft fixed to one end of a blade receiving wind power and rotating together with the blade, an output shaft connected to the generator, and a speed increasing mechanism arranged between the input shaft and the output shaft and increasing the rotation speed of the input shaft and transferring it to the output shaft. The speed increasing mechanism comprises a helical gear as one component of power transferring means and a double row roller bearing rotatably supporting the shaft of the helical gear. Focusing on the double row roller bearing, it is characterized in that the load capacities in the right and left rows are differentiated from each other such that the load capacity of the row receiving a high axial load is larger.

According to the present invention, when the bearings having different load capacities in the right and left rows is used in the helical gear supporting structure in which different loads are applied to the right and left rows of the bearing, since the appropriate support according to the load status of each row can be implemented, the helical gear supporting structure is high in reliability and has a long lifetime.

A vertical shaft supporting structure according to the present invention comprises a vertical shaft, and a double row roller bearing incorporated in a fixing member and rotatably supporting the vertical shaft. Focusing on the double row roller bearing, it is characterized in that the load capacities in the right and left rows are differentiated from each other such that the load capacity of the row receiving a high axial load is larger.

According to the above constitution, since appropriate support according to the characteristics of the load applied to the vertical shaft can be implemented, the vertical shaft supporting structure is high in reliability and has a long lifetime.

It is preferable that the double row roller bearing is a double row self-aligning roller bearing comprising an inner ring having track surfaces in the right and left rows, an outer ring having a spherically recessed track surface, and spherical rollers arranged in double rows between the inner ring and the outer ring. Thus, the double row roller bearing has self-alignment properties against center displacement due to deflection of the shaft and the like.

Preferably, the double row self-aligning roller bearing has different roller lengths in the right and left rows and the roller length of the roller in the row receiving a high axial load is longer. Thus, the load capacity of the row having the longer spherical roller can be higher.

Preferably, the double row self-aligning roller bearing has different roller diameters in the right and left rows and the roller diameter of the roller in the row receiving a high axial load is larger. Thus, the load capacity of the row having the larger diameter can be higher.

Furthermore, it is preferable that the double row self-aligning roller bearing has the same contact angle in the right and left rows. Thus, since the symmetric standard ring can be used for the outer ring, the manufacturing cost can be low. Furthermore, since the right and left rows can be measured under the same measurement condition in measuring the track diameter of the outer ring track surface, surface roughness, roundness (referred to as dimension hereinafter), the measurement can be effectively made.

It is preferable that the double row roller bearing is a double row conical roller bearing comprising an inner ring having track surfaces in the right and left rows, an outer ring, and conical rollers arranged in double rows between the inner ring and the outer ring.

Preferably, the double row conical roller bearing is a back-to-back bearing in which the small diameter side ends of the conical rollers in the right and left rows are opposed. In this constitution, the distance between intersections of the center line of the rotation of the bearing with contact lines of the conical rollers in the right and left rows and the inner and outer rings (referred to as the distance between points of action hereinafter) is long, radial load carrying capacitance and moment load carrying capacitance can be improved.

It is preferable that the double row conical roller bearing is a face-to-face bearing in which the large diameter side ends of the conical rollers in the right and left rows are opposed.

Preferably, the double row conical roller bearing has different roller lengths in the right and left rows and the roller length of the roller in the row receiving a high axial load is longer.

Preferably, the double row conical roller bearing has different roller diameters in the right and left rows and the roller diameter of the roller in the row receiving a high axial load is larger.

According to the present invention, when the bearings having different load capacities in the right and left rows is used in the vertical shaft supporting structure in which different loads are applied to the right and left rows of the bearing, since the appropriate support according to the load status of each row can be implemented, the vertical shaft supporting structure is high in reliability and has a long lifetime.

### BRIEF DESCRIPTION OF DRAWINGS

FIG. 1 is a schematic view showing a conventional speed increaser for a wind power generator;

FIG. 2A is a view showing the state in which a pair of helical gears engages;

FIG. 2B is a view showing the direction of a load applied at the time of rotation;

FIG. 3 is a schematic sectional view showing a conventional swing speed reducer;

FIG. 4 is a view showing a bearing used in a helical gear supporting structure and a vertical shaft supporting structure according to the present invention in which a double row self-aligning roller bearing having different roller lengths in right and left rows is provided;

FIG. 5 is a view showing a bearing used in the helical gear supporting structure and the vertical shaft supporting structure according to the present invention in which a double row self-aligning roller bearing having different roller lengths in right and left rows and having the same contact angle of the right and left rows of the bearing is provided;

FIG. 6 is a view showing a face-to-face bearing used in the helical gear supporting structure and the vertical shaft supporting structure according to the present invention in which a double row conical roller bearing having different roller lengths in right and left rows is provided;

FIG. 7 is a view showing a back-to-back bearing used in the helical gear supporting structure and the vertical shaft supporting structure according to the present invention in which a double row conical roller bearing having different roller lengths in right and left rows is provided; and

FIG. 8 is a schematic view showing a speed increaser for a wind power generator according to another embodiment of the present invention.

### BEST MODE FOR CARRYING OUT THE INVENTION

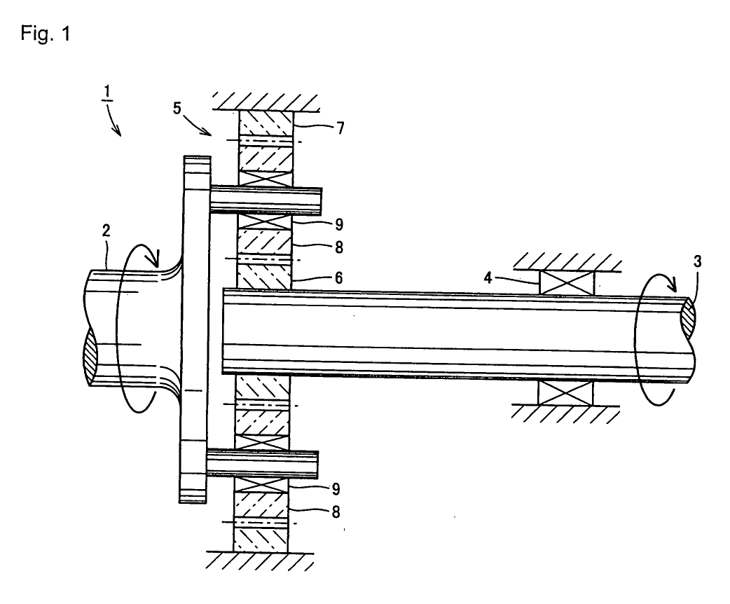

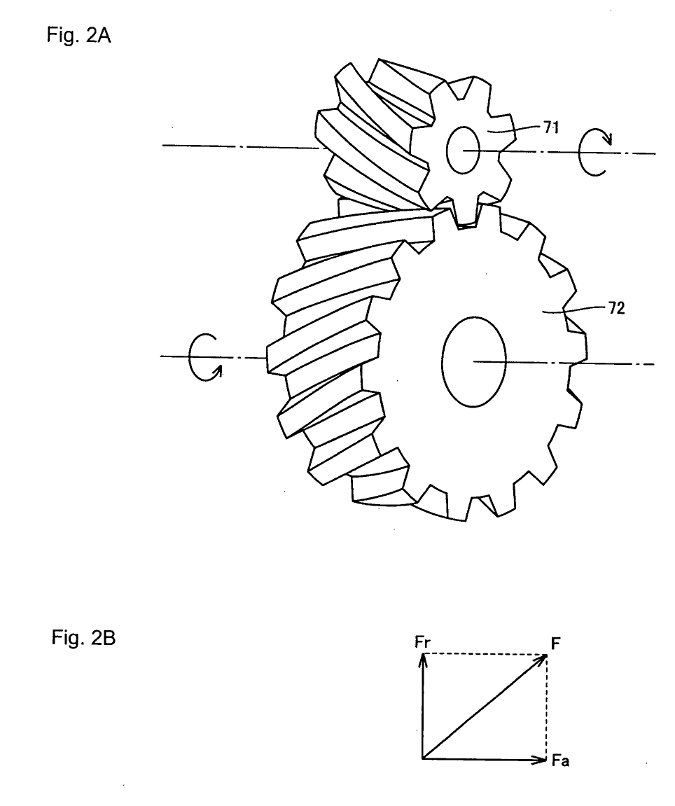

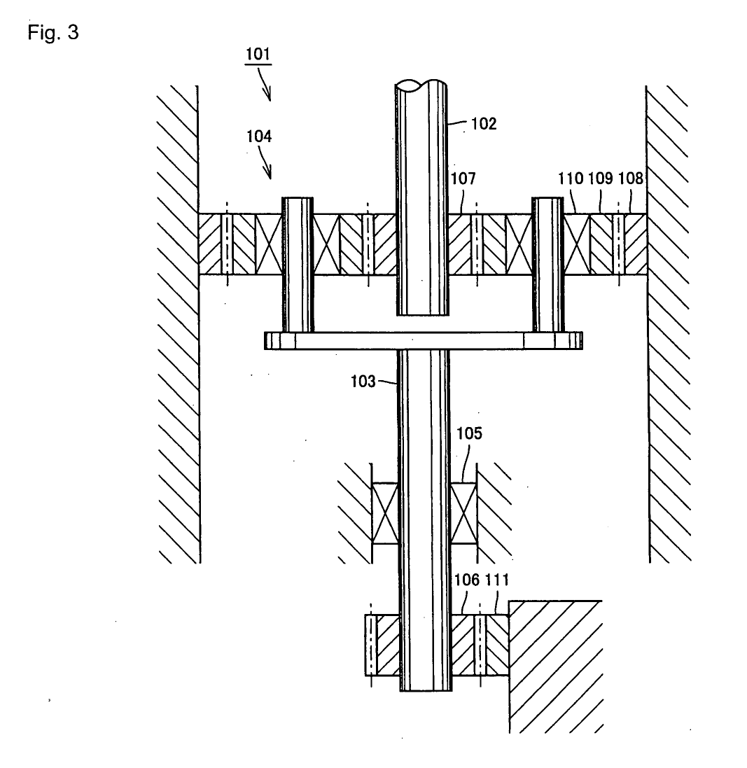

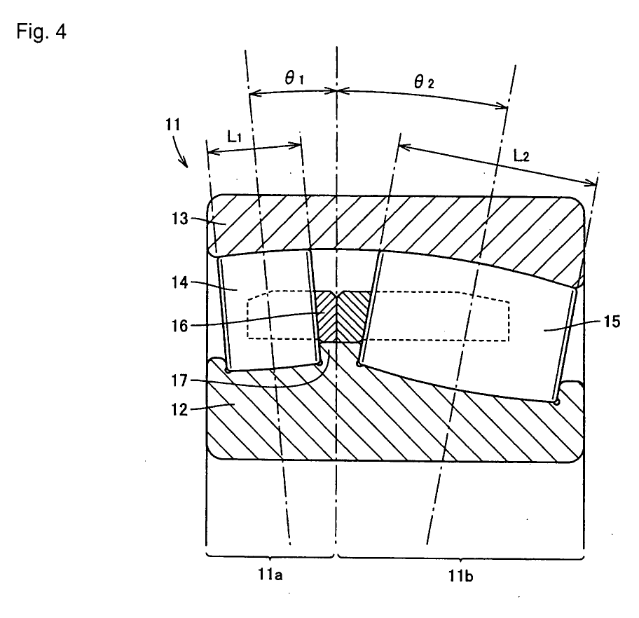

With reference to FIG. 4, a description will be made of a double row roller bearing used in a helical gear supporting structure and a vertical shaft supporting structure according to the present invention such as a speed increaser 1 for a wind power generator shown in FIG. 1 and a swing speed reducer 101 shown in FIG. 3.

The double row roller bearing shown in FIG. 4 is a double row self-aligning roller bearing 11 comprising an inner ring 12, an outer ring 13, spherical rollers 14 and 15 arranged in double rows between the inner ring 12 and the outer ring 13, and a retainer 16 for retaining the spherical rollers 14 and 15.

The inner ring 12 has a track surface along the outer diameter surfaces of the spherical rollers 14 and 15, and a middle flange 17, and the outer ring 13 has a track surface common to the spherical rollers 14 and 15 along them. Regarding the roller lengths L₁ and L₂ of the spherical rollers 14 and 15, the length L₂ of the spherical roller 15 is set to be longer than the L₁ of the spherical roller 14.

Furthermore, regarding the contact angles θ₁ and θ₂ formed between a plane vertical to the bearing center axis and lines of action of resultant force transferred from the inner ring 12 and the outer ring 13 to the spherical rollers 14 and 15 in the right and left rows, the contact angle θ₂ of the bearing 11b in the right row is set to be larger than the contact angle θ₁ of the bearing 11a in the left row.

According to the double row self-alignment roller bearing 11 having the above constitution, since the roller length in the right row is differentiated from that in the left row, the load capacity of the bearing 11b of the longer spherical roller 15 can be higher than that of the bearing 11a of the spherical roller 14. Furthermore, since the contact angles of the right and left rows are differentiated, the axial load carrying capacitance of the bearing 11b in the right row having the larger contact angle can be higher than that of the bearing 11a in the left row.

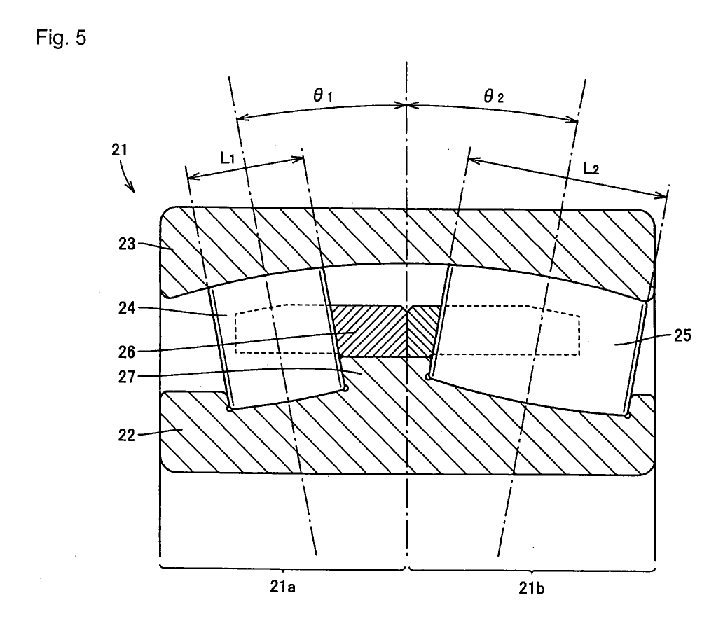

Next, a description will be made of another embodiment of the double row roller bearing used in the helical gear supporting structure and the vertical shaft supporting structure according to the present invention with reference to FIG. 5.

A double row roller bearing shown in FIG. 5 is a double row self-aligning roller bearing 21 comprising an inner ring 22 having a middle flange 27, an outer ring 23 having a spherically recessed track surface, spherical rollers 24 and 25 arranged in double rows between the inner ring 22 and the outer ring 23 and having different roller lengths L₁ and L₂ in the right and left rows, respectively and a retainer 26 for retaining the spherical rollers 24 and 25.

In addition, the contact angles θ₁ and θ₂ of the bearings 21a and 21b in the right and left rows are the same. Thus, since a symmetric standard ring can be used for the outer ring 23, its manufacturing cost can be low. Furthermore, when precision of the outer ring 23 is measured, since the right and left rows can be measured under the same measuring condition, the measurement can be effectively made.

In addition, although a symmetric roller is used as the spherical roller in the double row self-aligned roller bearings shown in FIGS. 4 and 5, an asymmetric roller in which the maximum diameter position of the roller does not exist in the center of the roller in its length direction may be used instead. In the case where the asymmetric roller is used, when the double row self-aligning roller bearing receives a load, an induced thrust load is generated and the spherical roller is pressed against the middle flange, so that the position of the roller can be stable and its skew can be prevented.

Furthermore, although the inner ring has the middle flange in the above embodiment, the present invention is not limited to this. For example, the inner ring may not have the middle flange or it has a guide ring guided by the inner ring or the outer ring.

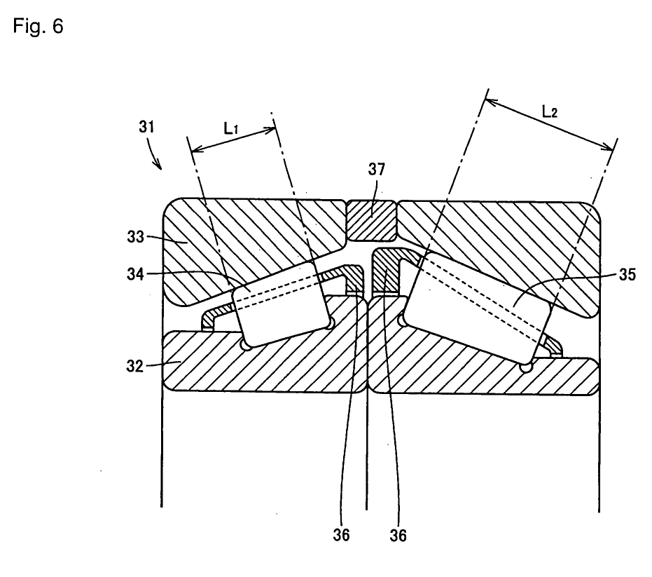

Next, another embodiment of the double row roller bearing used in the helical gear supporting structure and the vertical shaft supporting structure according to the present invention will be described with reference to FIG. 6.

The double row roller bearing shown in FIG. 6 is a double row conical roller bearing 31 comprising an inner ring 32 in which the large diameter side ends of two inner ring members abut on each other, an outer ring 33 in which two outer ring members abut on each other with a filler piece 37 sandwiched between them, conical rollers 34 and 35 arranged between the inner ring 32 and the outer ring 33 and having different roller lengths in the right and left rows, and a retainer 36 for retaining the conical rollers 34 and 35.

In addition, the double row conical roller bearing 31 is a face-to-face bearing in which the large diameter side ends of the conical rollers in the right and left rows are opposed to each other.

According to the double row conical roller bearing 31 having the above constitution, since a length L₂ Of the conical roller 35 is made longer than a length L₁ of the conical roller 34, axial load carrying capacitance is higher in the row of the longer conical roller 35.

In addition, according to the double row conical roller bearing 31 shown in FIG. 6, the inner ring 32 may be integrally formed.

When the double row roller bearings shown in FIGS. 4 to 6 are applied to the bearing 4 of the speed reducer 1 for the wind power generator shown in FIG. 1, the row in which the load capacity of the bearing is made higher is arranged on the side far from the planet gear mechanism 5. In addition, when they are applied to the double row roller bearing 105 of the swing speed reducer 101 shown in FIG. 3, the row having the high axial load carrying capacitance of the bearing is arranged on the lower side. Thus, since appropriate support according to the load status can be provided, the helical gear supporting structure and the vertical shaft supporting structure are high in reliability and have a long life.

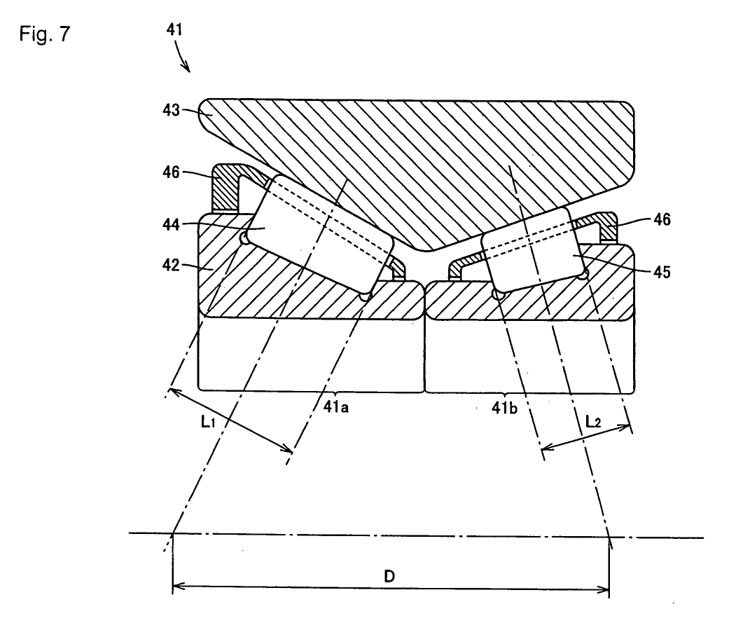

Next, another embodiment of the double row roller bearing used in the helical gear supporting structure and the vertical shaft supporting structure according to the present invention will be described with reference to FIG. 7.

The double row roller bearing shown in FIG. 7 is a double row conical roller bearing 41 comprising an inner ring 42 in which the small diameter side ends of two inner ring members abut on each other, an outer ring 43, conical rollers 44 and 45 arranged between the inner ring 42 and the outer ring 43 and having different roller lengths in the right and left rows, and a retainer 46 for retaining the conical rollers 44 and 45.

In addition, the double row conical roller bearing 41 is a back-to-back bearing in which the small diameter side ends of the conical rollers in the right and left rows are opposed to each other.

According to the double row conical roller bearing 41 having the above constitution, since a length L₁ of the conical roller 44 is made longer than a length L₂ of the conical roller 45, axial load carrying capacitance is higher in the row of the longer conical roller 44.

In addition, since the double row conical roller bearing 41 is arranged back-to-back, the distance between the points of action of the bearing is long, so that radial load carrying capacitance and moment load carrying capacitance are improved.

When the double row conical roller bearing 41 is applied to the bearing 4 of the speed reducer 1 of a wind power generator shown in FIG. 1, a bearing 41a that can support both radial load and axial load is arranged to the side close to the planet gear mechanism 5. Thus, since appropriate support according to the load status can be provided, the helical gear supporting structure is highly reliable and have a long life.

In addition, when the double row conical roller bearing 41 is applied to the double row roller bearing 105 of the swing speed reducer 101 shown in FIG. 3, the bearing 41a having the high axial load carrying capacitance is arranged on the upper side. Thus, since the appropriate support according to the load status can be provided, the vertical shaft supporting structure can be highly reliable and have long life.

Although the load capacities in the right and left rows of the bearing are differentiated by differentiating the roller lengths in the right and left rows in the above embodiments shown in FIGS. 4 to 7, the roller diameters in the right and left rows may be differentiated, or one roller may be a solid roller while the other roller is a hollow roller having a through hole penetrating both end faces. Furthermore, the load capacities in the right and left rows of the bearing can be effectively differentiated by combining the above.

When the roller diameters in the right and left rows of bearing are differentiated from each other, the load capacity of the bearing having the larger roller diameter can be large. In addition, when one roller in the right and left rows of the bearing is solid and the other is hollow, the load capacity of the bearing where the solid roller is arranged can be large. In this case, since the rollers having the same length and diameter can be used in the right and left rows in the bearing, the inner ring and the outer ring can be standard rings, so that the manufacturing cost can be low.

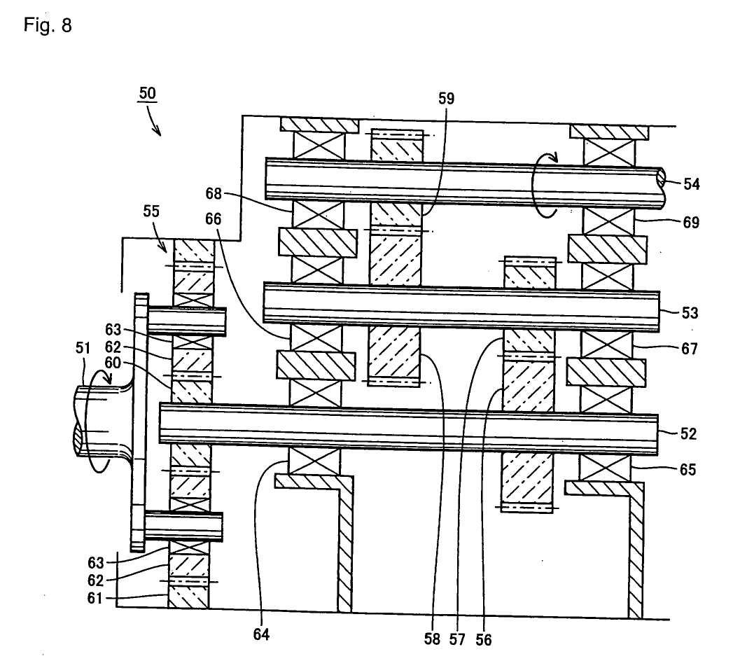

Next, a description will be made of the constitution of the speed increaser for the wind power generator as the helical gear supporting structure according to the present invention with reference to FIG. 8.

A speed increaser 50 for a wind power generator comprises a first speed increasing system comprising an input shaft 51 that rotates together with a blade receiving wind power, a middle shaft 52, and a planet gear mechanism 55 that increases the rotation speed of the input shaft 51 and transfers it to the middle shaft 52, and a second speed increasing system comprising middle shafts 52 and 53, an output shaft 54 connected to the generator, and a parallel shaft gear mechanism that connects the middle shafts 52 and 53 and the output shaft 54 by helical gears 56 to 59.

The planet gear mechanism 55 comprises a sun gear 60 connected to the middle shaft 52, and an internal gear 61 fixed to a housing, and a planet gear 62 connected to the input shaft 51 through a bearing 63 and engaging with the sun gear 60 and the internal gear 61. The helical gear is used for the sun gear 60, the internal gear 61 and the planet gear 62.

The middle shafts 52 and 53 and the output shaft 54 are supported by double row roller bearings 64 to 69 fixed to the housing.

When the planet gear 62 goes around the sun gear 60 with the rotation of the input shaft 51, the first speed increasing system engages with the internal gear 61 and rotates. The sun gear 60 engages with the rotating planet gear 62 and transfers the rotation of the input shaft 51 to the middle shaft 52. At this time, the more the difference in the number of the teeth between the sun gear 60 and the internal gear 61 is, the more the rotation speed of the input shaft 51 is increased and it is transferred to the middle shaft 52.

The second speed increaser system transfers the rotation of the middle shaft 52 to the output shaft 54 by the helical gears 56 to 59 through the middle shaft 53. At this time, the more the difference in the number of teeth between the helical gears 56 and 57 and between the helical gears 58 and 59 is, the more the rotation speed of the middle shaft 52 is increased and it is transferred to the output shaft 54.

Although a spur gear may be used for a part or the whole of the gears used in the speed increaser 50 for the wind power generator, when the helical gear is used, the speed increaser can be smooth in transmission and low in vibration sound and transfer great force.

According to the speed increaser 50 for the wind power generator, the input shaft 51, the middle shafts 52 and 53 and the output shaft 54 receive axial load when they engage with the helical gear. Thus, when the double row roller bearings shown in FIGS. 4 to 7 are used as the double row roller bearing for supporting each shaft, since appropriate support according to the load status of each row can be provided, the speed increaser for the wind power generator can be high in reliability and have a long life.

Next, a description will be made of the case where the double row roller bearings shown in FIGS. 4 to 7 are applied to the double row roller bearing for supporting the output shaft 54 hereinafter.

When the output shaft 54 rotates clockwise viewed from the double row roller bearing 69, the output shaft 54 receives the axial load from the helical gear 59 to the right direction in the drawing.

In this case, when the double row roller bearings shown in FIGS. 4 to 6 are used for the double row roller bearings 68 and 69, the row having high load capacity of the bearing is to be arranged in the row close to the helical gear 59 in the double row roller bearing 68 and in the row far from the helical gear 59 in the double row roller bearing 69. Meanwhile, when the double row roller bearing shown in FIG. 7 is used for the double row roller bearings 68 and 69, the row having high load capacity of the bearing is to be arranged in the row far from the helical gear 59 in the double row roller bearing 68 and in the row close to the helical gear 59 in the double row roller bearing 69.

Although the embodiments shown in FIGS. 4 to 7 can be also applied to the double row roller bearing supporting the output shaft 102 of the swift speed reducer shown in FIG. 3, the present invention is not limited to this. For example, they can be applied to the vertical shaft supporting structure to which the axial load is applied by gravitation.

Although the embodiments of the present invention have been described with reference to the drawings in the above, the present invention is not limited to the above-illustrated embodiments. Various kinds of modifications and variations may be added to the illustrated embodiments within the same or equal scope of the present invention.

### INDUSTRIAL APPLICABILITY

The present invention can be advantageously applied to the supporting structure of a helical gear and a vertical shaft supporting structure.

1. A helical gear supporting structure comprising:
a helical gear having a center shaft; and
a double row roller bearing incorporated in a fixing member and rotatably supporting the center shaft, characterized in that
said double roller bearing has different load capacities in the right and left rows and the load capacity of the row receiving a high axial load is larger.

2. The helical gear supporting structure according to claim 1, wherein
said double row roller bearing is a double row self-aligning roller bearing comprising an inner ring having track surfaces in the right and left rows, an outer ring having a spherically recessed track surface, and spherical rollers arranged in double rows between said inner ring and said outer ring.

3. The helical gear supporting structure according to claim 2, wherein
said double row self-aligning roller bearing has different roller lengths in the right and left rows and the roller length of the roller in the row receiving a high axial load is longer.

4. The helical gear supporting structure according to claim 2, wherein
said double row self-aligning roller bearing has different roller diameters in the right and left rows and the roller diameter of the roller in the row receiving a high axial load is larger.

5. The helical gear supporting structure according to claim 2, wherein
said double row self-aligning roller bearing has the same contact angle in the right and left rows.

6. The helical gear supporting structure according to claim 1, wherein
said double row roller bearing is a double row conical roller bearing comprising an inner ring having track surfaces in the right and left rows, an outer ring, and conical rollers arranged in double rows between said inner ring and said outer ring.

7. The helical gear supporting structure according to claim 6, wherein
said double row conical roller bearing is a back-to-back bearing in which small diameter side ends of the conical rollers in the right and left rows are opposed.

8. The helical gear supporting structure according to claim 6, wherein
said double row conical roller bearing is a face-to-face bearing in which large diameter side ends of the conical rollers in the right and left rows are opposed.

9. The helical gear supporting structure according to claim 6, wherein
said double row conical roller bearing has different roller lengths in the right and left rows and the roller length of the roller in the row receiving a high axial load is longer.

10. The helical gear supporting structure according to claim 6, wherein
said double row conical roller bearing has different roller diameters in the right and left rows and the roller diameter of the roller in the row receiving a high axial load is larger.

11. A speed increaser for a wind power generator comprising:
an input shaft fixed to one end of a blade receiving wind power and rotating together with the blade;
an output shaft connected to the generator; and
a speed increasing mechanism arranged between said input shaft and said output shaft and increasing the rotation speed of said input shaft and transferring it to said output shaft, characterized in that
said speed increasing mechanism comprises a helical gear as one component of power transferring means and a double row roller bearing rotatably supporting the shaft of said helical gear, and
said double row roller bearing has different load capacities in the right and left rows and the load capacity in the row receiving a large axial load is larger.

12. A vertical shaft supporting structure comprising:
a vertical shaft, and
a double row roller bearing incorporated in a fixed member and rotatably supporting said vertical shaft, characterized in that
said double row roller bearing has different load capacities in the right and left rows and the load capacity in the row receiving a large axial load is larger.

13. The vertical shaft supporting structure according to claim 12, wherein
said double row roller bearing is a double row self-aligning roller bearing comprising an inner ring having track surfaces in the right and left rows, an outer ring having a spherically recessed track surface, and spherical rollers arranged in double rows between said inner ring and said outer ring.

14. The vertical shaft supporting structure according to claim 13, wherein
said double row self-aligning roller bearing has different roller lengths in the right and left rows and the roller length of the roller in the row receiving a high axial load is longer.

15. The vertical shaft supporting structure according to claim 13, wherein
said double row self-aligning roller bearing has different roller diameters in the right and left rows and the roller diameter of the roller in the row receiving a high axial load is larger.

16. The vertical supporting structure according to claim 13, wherein
said double row self-aligning roller bearing has the same contact angle in the right and left rows.

17. The vertical shaft supporting structure according to claim 12, wherein
said double row roller bearing is a double row conical roller bearing comprising an inner ring having track surfaces in the right and left rows, an outer ring, and conical rollers arranged in double rows between said inner ring and said outer ring.

18. The vertical shaft supporting structure according to claim 17, wherein
said double row conical roller bearing is a back-to-back bearing in which small diameter side ends of the conical rollers in the right and left rows are opposed.

19. The vertical shaft supporting structure according to claim 17, wherein
said double row conical roller bearing is a face-to-face bearing in which large diameter side ends of the conical rollers in the right and left rows are opposed.

20. The vertical shaft supporting structure according to claim 17, wherein
said double row conical roller bearing has different roller lengths in the right and left rows and the roller length of the roller in the row receiving a high axial load is longer.

21. The vertical shaft supporting structure according to claim 17, wherein
said double row conical roller bearing has different roller diameters in the right and left rows and the roller diameter of the roller in the row receiving a high axial load is larger.
